(19) United States
(12) Patent Application Publication
(10) Pub. No.: US 2017/0261745 A1
(43) Pub. Date: Sep. 14, 2017

(54) VIRTUAL REALITY METHODS AND SYSTEMS

(71) Applicant: Brown University, Providence, RI (US)

(72) Inventors: Michael Fitzgerald, Arlington, MA (US); Stéphane Bonneaud, Paris (FR); William Warren, Cranston, RI (US); Gabriel Taubin, Providence, RI (US)

(21) Appl. No.: 15/331,156

(22) Filed: Oct. 21, 2016

Related U.S. Application Data
(63) Continuation of application No. 14/526,404, filed on Oct. 28, 2014, now abandoned.
(60) Provisional application No. 61/896,329, filed on Oct. 28, 2013.

(51) Int. Cl. G02B 27/01; G06F 3/01

(52) U.S. Cl. CPC G02B 27/01; G06F 3/012; G02B 27/017; G02B 2027/0134; G02B 2027/0138; G02B 2027/014; G02B 2027/0181

(57) ABSTRACT

Some aspects include a virtual reality device configured to present to a user a virtual environment. The virtual reality device comprises a tracking device including at least one camera to acquire image data, the tracking device, when worn by the user, configured to determine a position associated with the user and a stereoscopic display device configured to display at least a portion of a representation of the virtual environment, wherein the representation of the virtual environment is based, at least in part, on the determined position associated with the user, wherein the display device and the tracking device are configured to be worn by the user.

### CROSS-REFERENCE TO RELATED APPLICATIONS

This application claims the benefit under 35 U.S.C. §120 and is a continuation of U.S. application Ser. No. 14/526,404, entitled “VIRTUAL REALITY METHODS AND SYSTEMS” filed on Oct. 28, 2014 under Attorney Docket No. B0877.70046US01, which claims the benefit under 35 U.S.C. §119(e) of U.S. Provisional Application Ser. No. 61/896,329, titled “VIRTUAL REALITY METHODS AND SYSTEMS” and filed on Oct. 28, 2013 under Attorney Docket No. B0877.70046US00, which are herein incorporated by reference in their entireties.

### STATEMENT REGARDING FEDERALLY SPONSORED RESEARCH OR DEVELOPMENT

This invention was made with government support under Grant No. 5R01EY010923 awarded by the National Institutes of Health. The government has certain rights in the invention.

### BACKGROUND

Virtual reality (VR) systems simulate an environment by modeling the environment and presenting the modeled environment to users in a manner that allows aspects of the environment to be perceived (e.g., sensed) to give the impression that the user is in the environment to the extent possible. The virtual environment simulated by a VR system may correspond to a real environment (e.g., a VR flight simulator may simulate the cockpit of a real airplane), an imagined environment (e.g., a VR flight game simulator may simulate an imagined aerial setting), or some combination of real and imagined environments. A VR system may, for example, stimulate a user's sense of sight by displaying images of the simulated environment, stimulate a user's sense of sound by playing audio of the simulated environment, and/or stimulate a user's sense of touch by using haptic technology to apply force to the user.

A key aspect of many VR systems lies in the ability to visually display a three-dimensional environment to a user that responds to the user visually exploring the virtual environment. This is frequently achieved by providing separate visual input to the right and left eyes of the user to emulate how the eyes and visual cortex experience real environments. Systems that provide separate visual input to each eye are referred to herein as “stereoscopic” or “binocular.” While some VR systems provide a single visual input to both eyes, such systems are typically less immersive as they lack the perception of depth and three-dimensionality of stereoscopic systems. Accordingly, stereoscopic systems generally provide a more realistic rendering of the environment.

To allow a user to explore a virtual environment, a VR system may track the position and/or orientation of a user's head in the real world, and render the visual model in correspondence to the user's changing perspective to create the perception that the user is moving in and/or looking around the virtual environment. The ability to explore a virtual environment contributes to the immersive character of the virtual reality experience, particularly those environments that react to the user's motion or locomotion in the environment.

### BRIEF DESCRIPTION OF THE DRAWINGS

Various aspects and embodiments of the technology will be described with reference to the following figures. It should be appreciated that the figures are not necessarily drawn to scale.

FIG. 1 is a block diagram of a virtual reality system 100, according to some embodiments;

FIG. 2 is a block diagram of an example of a conventional VR system 200;

FIG. 3 is a schematic of a wireless virtual environment presenting unit 300, according to some embodiments;

FIG. 4 is a schematic of a virtual reality system 400, according to some embodiments;

FIG. 5 is a block diagram of an integrated virtual reality device 480, according to some embodiments;

FIG. 6A shows a flowchart illustrating a method for displaying a virtual environment, according to some embodiments;

FIG. 6B shows a flowchart illustrating a method for determining a position of a user of a virtual reality device, according to some embodiments; and

FIG. 7 shows an illustrative implementation of a computer system that may be used to implement one or more components and/or techniques described herein.

### SUMMARY

Some embodiments include a virtual reality device configured to present to a user a virtual environment. The virtual reality device comprises a tracking device including at least one camera to acquire image data, the tracking device, when worn by the user, configured to determine a position associated with the user and a stereoscopic display device configured to display at least a portion of a representation of the virtual environment, wherein the representation of the virtual environment is based, at least in part, on the determined position associated with the user, wherein the display device and the tracking device are configured to be worn by the user.

### DETAILED DESCRIPTION

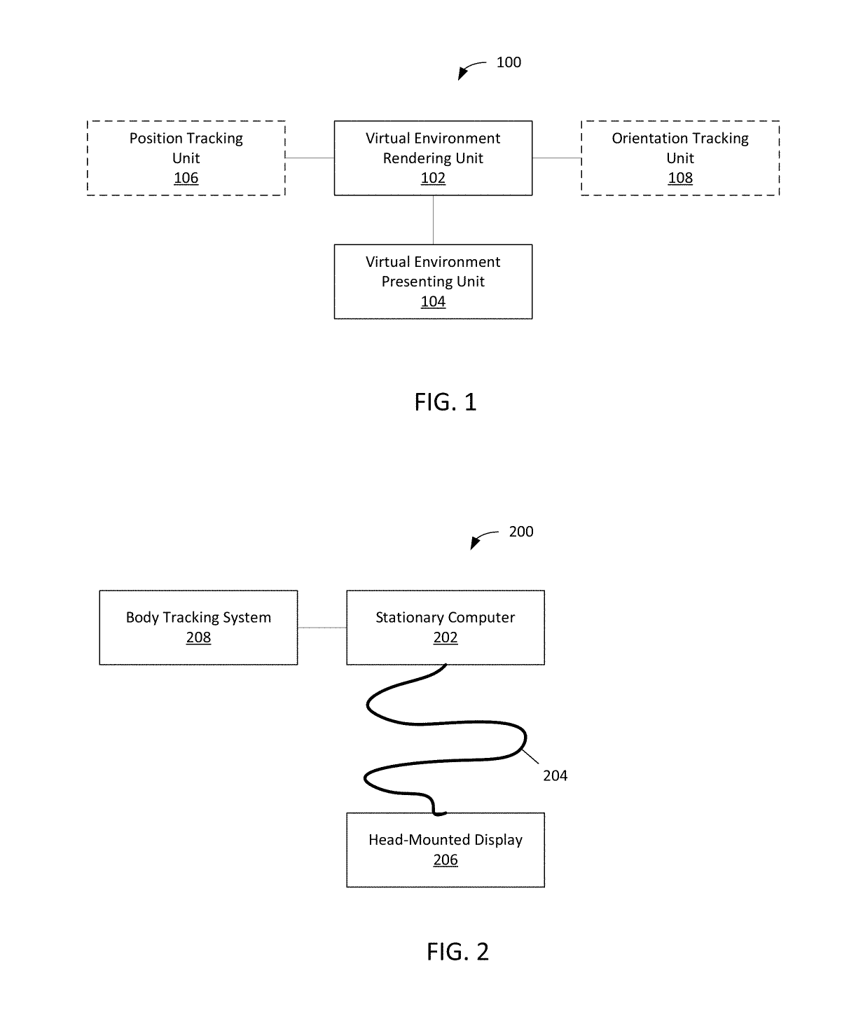

As discussed above, many VR systems attempt to realistically present an environment to a user that is responsive to a user's interaction with the environment. For example, a VR system may visually display a scene to a user, the perspective of which changes in real-time corresponding to the user's changing relationship with the scene. To do so effectively, the location of the user and direction in which the user's head is facing typically are tracked so that the scene can be rendered from the correct perspective. An example system configured to simulate a virtual environment that is responsive to the user's movement in the environment is discussed below in connection with FIG. 1. The system described in FIG. 1 is characteristic of many VR systems and describes components and functionality that a VR system may include and/or utilize. It should be appreciated, however, that the components, features and functionality described in connection with FIG. 1 are not requirements or limitations with respect to the techniques and systems disclosed herein.

FIG. 1 is a block diagram of a virtual reality system 100, according to some embodiments. VR system 100 includes a virtual environment rendering unit 102, a virtual environment presenting unit 104, (optionally) a position tracking unit 106, and (optionally) an orientation tracking unit 108. In some embodiments, virtual environment rendering unit 102 uses a model of a virtual environment to render a representation of the virtual environment. Typically, the virtual environment rendering unit 102 comprises one or more computers programmed to maintain the model of the virtual environment and render the representation of the virtual environment responsive to the user's changing perspective (e.g., changes in perspective resulting from the user's interaction with the virtual environment). In this respect, virtual environment rendering unit 102 may include a visual component to generate a visual representation of the environment that changes responsive to the user's movement and/or change in the user's head orientation in connection with the virtual representation.

In addition to a visual component, VR system may include an audible component and/or a tactile component. The audible component may include audio data configured to stimulate a user's auditory perception of the virtual environment, and the tactile component may include haptic data configured to stimulate a user's tactile perception of the virtual environment. For example, embodiments of virtual environment rendering unit 102 may render representations that attempt to mimic the sights, sounds, and/or tactile sensations a person would see, hear, and/or feel if the person were present in an actual environment characteristic of the virtual environment being simulated.

In some embodiments, virtual environment presenting unit 104 may present the rendered representation of the virtual environment to a user of the VR system via techniques that allow the user to perceive the rendered aspects of the virtual environment. For example, the visual component of a virtual environment may be displayed by the virtual environment presenting unit 104 via a head mounted display capable of providing images and/or video to the user. As discussed above, head mounted displays that can display a scene stereoscopically typically provide a more realistic environment and/or achieve a more immersive experience. A number of head mounted display types are discussed in further detail below.

A virtual environment presenting unit 104 may also include components adapted to provide an audible component of the virtual environment to the user (e.g., via headphones, ear pieces, speakers, etc.), and/or components capable of converting a tactile component of the virtual environment into forces perceptible to the user (e.g., via a haptic interface device). In some embodiments, virtual environment presenting unit 104 may include one or more components configured to display images (e.g., a display device), play sounds (e.g., a speaker), and/or apply forces (e.g., a haptic interface), while in some embodiments, virtual environment presenting unit 104 may control one or more components configured to display images, play sounds, and/or apply forces to the user, and the particular configuration is not limiting.

In some embodiments, position tracking unit 106 determines a position of an object in a reference environment and generates reference positioning data representing the object's position in the reference environment. The object may be a person (e.g., a user of VR system 100), a part of a person (e.g., a body part of a user of VR system 100), or any suitable object. The type of object tracked by position tracking unit 106 may depend on the nature of the virtual environment and/or the intended application of the virtual environment. In some embodiments, position tracking unit 106 may include a satellite navigation system receiver (e.g., a global positioning system (GPS) receiver or a global navigation satellite system (GLONASS) receiver), a motion capture system (e.g., a system that uses cameras and/or infrared emitters to determine an object's position), an inertial motion unit (e.g., a unit that includes one or more accelerometers, gyroscopes, and/or magnetometers to determine an object's position), an ultrasonic system, an electromagnetic system, and/or any other positioning system suitable for determining a position of an object. The reference positioning data may include, but are not limited to, any one or combination of satellite navigation system data (e.g., GPS data or GLONASS data) or other suitable positioning data indicating an object's position in the real world, motion capture system data indicating an object's position in a monitored space, inertial system data indicating an object's position in a real or virtual coordinate system, and/or any other data suitable for determining a position of a corresponding virtual object in the virtual environment.

Virtual environment rendering unit 102 may process the reference positioning data to determine a position of the object in the virtual environment. For example, in cases where the reference positioning data includes the position of a user of VR system 100, virtual environment rendering unit 102 may determine the user's position in the virtual environment (“virtual position”) and use the user's virtual position to determine at least some aspects of the rendered representation of the virtual environment. For example, virtual environment rendering unit 102 may use the user's virtual position to determine, at least in part, the sights, sounds, and/or tactile sensations to render that correspond to the user's current relationship with the virtual environment. In some embodiments, virtual environment rendering unit 102 may use the user's virtual position to render a virtual character (e.g., an avatar) corresponding to the user at the user's virtual position in the virtual environment.

Likewise, in cases where the reference positioning data includes the position of a part of a user of VR system 100, virtual environment rendering unit 102 may determine the virtual position of the part and use the part's virtual position to determine at least some aspects of the rendered representation of the virtual environment. For example, virtual environment rendering unit 102 may use the position of a user's head to determine, at least in part, how the virtual environment should be rendered, how to render the representation of a virtual character (e.g., an avatar), or both.

In some embodiments, orientation tracking unit 108 determines an orientation of an object in a reference environment and generates reference orientation data representing the object's orientation in the reference environment. The object may be a person (e.g., a user of VR system 100), a part of a person (e.g., a body part of a user of VR system 100, such as a head), or any other suitable object. For example, orientation tracking unit 108 may determine the orientation of a user's head to determine which direction the user is facing so as to enable rendering unit 102 to correctly render the scene from the perspective of the user. Some embodiments of orientation tracking unit 108 may include an accelerometer, a gyroscope, and/or any other suitable sensor attached to a real object and configured to determine an orientation of the real object in the reference environment. Some embodiments of orientation tracking unit 108 may include a motion capture system (e.g., a camera-based system) configured to determine an object's orientation in a monitored space, an inertial motion unit configured to determine an object's orientation in a virtual coordinate system, an eye-tracking system configured to determine an orientation of a user's eye(s), and/or any other apparatus configured to determine an orientation of an object in a reference environment. In some embodiments, orientation tracking unit 108 may determine an orientation of a virtual object in the virtual environment and generate virtual orientation data representing an orientation of the virtual object in the virtual environment based, at least in part, on reference orientation data representing the orientation of an object in the reference environment.

In some embodiments, virtual environment rendering unit 102 may process the reference orientation data to determine an orientation of a virtual object in the virtual environment. In cases where the reference orientation data includes the orientation of a user of VR system 100, virtual environment rendering unit 102 may determine the orientation in the virtual environment (“virtual orientation”) of a character corresponding to the user (e.g., an avatar or other suitable representation of the user) and process the character's virtual orientation to determine at least some aspects of the rendered representation of the virtual environment. For example, virtual environment rendering unit 102 may use the character's virtual orientation to determine, at least in part, the sights, sounds, and/or tactile sensations to render to the user to simulate a desired environment. In some embodiments, virtual environment rendering unit 102 may use the character's virtual orientation to render a representation of the character (e.g., an avatar) having a virtual orientation in the virtual environment based, at least in part, on the user's reference orientation.

Likewise, in cases where the reference orientation data includes the orientation of a part of a user of VR system 100, virtual environment rendering unit 102 may determine the virtual orientation of a part of a character corresponding to the part of the user (e.g., a part of an avatar or other suitable representation of the user) and process the virtual part's virtual orientation to determine at least some aspects of the rendered representation of the virtual environment. Virtual environment rendering unit 102 may use the virtual part's orientation to determine, at least in part, the sights, sounds, and/or tactile sensations to render to the user to simulate a desired environment. For example, virtual environment rendering unit 102 may use the reference orientation of a user's head and/or eyes to determine, at least in part, the virtual orientation of the head and/or eyes of a character corresponding to the user. Virtual environment rendering unit 102 may use the virtual orientation of the character's head and/or eyes to determine the images/sounds that would be visible/audible to a person having a head and/or eyes present in the virtual environment with the virtual orientation of the character's head and/or eyes. In some embodiments, virtual environment rendering unit 102 may use the virtual part's orientation to render a representation of the virtual part.

Conventional virtual reality systems are typically implemented using a generally high-speed server to generate the virtual environment in response to the user action (e.g., virtual rendering unit 102 is frequently implemented by one or more stationary computers) and communicate the virtual environment to a head mounted display via a wired connection. In a typical scenario, either a user will wear a back-pack that is both cable connected to the head mounted display and cable connected to the stationary computer programmed to dynamically generate the virtual environment, or the head mounted display will be cable connected to the stationary computer. The cable connections will typically include not only cables for the data, but power cables as well. As a result, the cable connection between the wearer of the head mounted display (e.g., from a backpack to the stationary computer or from the head mounted display to the stationary computer without a backpack) is restricted in movement by the cable connection, both in how far the user can venture in the environment and in general mobility. The presence of the cable connection also negatively impacts the immersive character of the system as the user remains cognizant of the cabling and must be careful to avoid disconnecting or breaking the connections. Frequently, another person must follow the wearer around to tend to the cable connection to ensure that the cabling does not trip the wearer, that the cabling does not become disconnected and/or the cabling does not so dramatically impact the experience that the virtual environment does not achieve its purpose. Such an exemplary conventional system is described in connection with FIG. 2.

FIG. 2 illustrates an example of a conventional VR system 200. Conventional VR system 200 includes a stationary computer 202, a cable bundle 204, a head-mounted display (HMD) 206, and a body tracking system 208. Stationary computer 202 (e.g., a desktop or server computer) uses a model of a virtual environment to render a representation of the scene to the user responsive to the user's interaction in the virtual environment. The rendered representation is transmitted to HMD 206 via cable bundle 204. HMD 206, which is configured to be worn on the head of a user of conventional VR system 200, uses complex optics to display the rendered images on a display device visible to the user. Body tracking system 208 tracks the user's position using tracking devices external to the user, often in combination with sensors attached to the user.

Conventional virtual reality systems have been significantly hampered by the limited user mobility provided. As discussed above, the cable connection between the stationary computer and the wearer of the head mounted display is restrictive. Additionally, the cable connection is frequently a source of malfunction and/or interruption, frequently needing maintenance and replacement and susceptible to being disconnected or damaged during use. Despite significant issues with the cable connection, it was conventionally believed a necessity to implement a stereoscopic system. In particular, attempts to replace the cable connection with a wireless connection were unsuccessful due to interference between the video channels of stereoscopic video for the user's right and left eye. As discussed above, rendering a scene stereoscopically typically involves providing different video to the right and left eyes (e.g., separate video streams) to more closely mimic the real experience of the human visual system. Conventional attempts to transmit the separate video components wirelessly resulted in unacceptable levels of interference between the two video signals.

The inventors have developed a stereoscopic virtual reality system implementing a wireless connection between a wearer of a head mounted display and the computer rendering the virtual environment that limits, substantially reduces or eliminates interference between the wireless stereoscopic video signals. According to some embodiments, dual wireless receivers are positioned in a unit worn by a user also wearing a head mounted display to wirelessly receive video signals from respective wireless transmitters. The dual wireless receivers may be configured to lock onto separate frequency ranges or bands such that the respective wireless video signals do not interfere with each other. According to some embodiments, the dual wireless receivers can communicate with each other to ensure that the frequency band to which the respective receiver locks is separate and distinct from the frequency band locked onto by the other wireless receiver. In this manner, the dual wireless receivers can automatically establish connections with their respective transmitters that avoid interfering with the other transmitter/receiver pair. The dual wireless receivers may be coupled to a head mounted display such that each receiver provides its respective video signal to a corresponding eye of the wearer, resulting in a wireless stereoscopic virtual reality system that substantially limits or avoids interference.

Such a wireless virtual reality system eliminates the cable connection (which conventionally may include one or more data cables and one or more power cables) between the wearer of the head mounted display and the computer, thus allowing for generally unrestricted movement in this respect. Allowing the user to move around without a cable tether and without having to be cognizant of avoiding the cable(s) realizes a substantially more immersive and free virtual reality system as well as facilitates the use of the virtual reality system in situations not achievable using conventional systems, and allows the virtual reality system to be utilized in a significantly wider range of applications than previously possible. Applications needing generally free and/or agile movement conventionally impeded by the cable(s) may be more readily implemented and may provide a more realistic experience to the user by replacing the cable connection with a wireless connection. In addition, the elimination of this cable connection removes a source of frequent maintenance, replacement and malfunction.

The inventors have also recognized and appreciated that conventional techniques for determining a user's position and/or orientation (e.g., external tracking devices configured to track the user's position and/or orientation only in a limited space) may restrict the user's movement by limiting the user to a relatively small and confined space, often one produced at substantial cost. In some embodiments, the techniques and devices disclosed herein may further reduce or eliminate restrictions on the user's mobility by integrating a mobile position and/or orientation tracking unit with the virtual reality device worn by the user. In some embodiments, the mobile position and/or orientation tracking unit may include a mobile motion capture unit configured to determine the user's position based, at least in part, on images obtained by one or more cameras worn by the user.

Following below are more detailed descriptions of various concepts related to, and embodiments of, a virtual reality system having a wireless connection between a wearer of a head mounted display and one or more computers adapted to dynamically generate a scene for a virtual environment. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

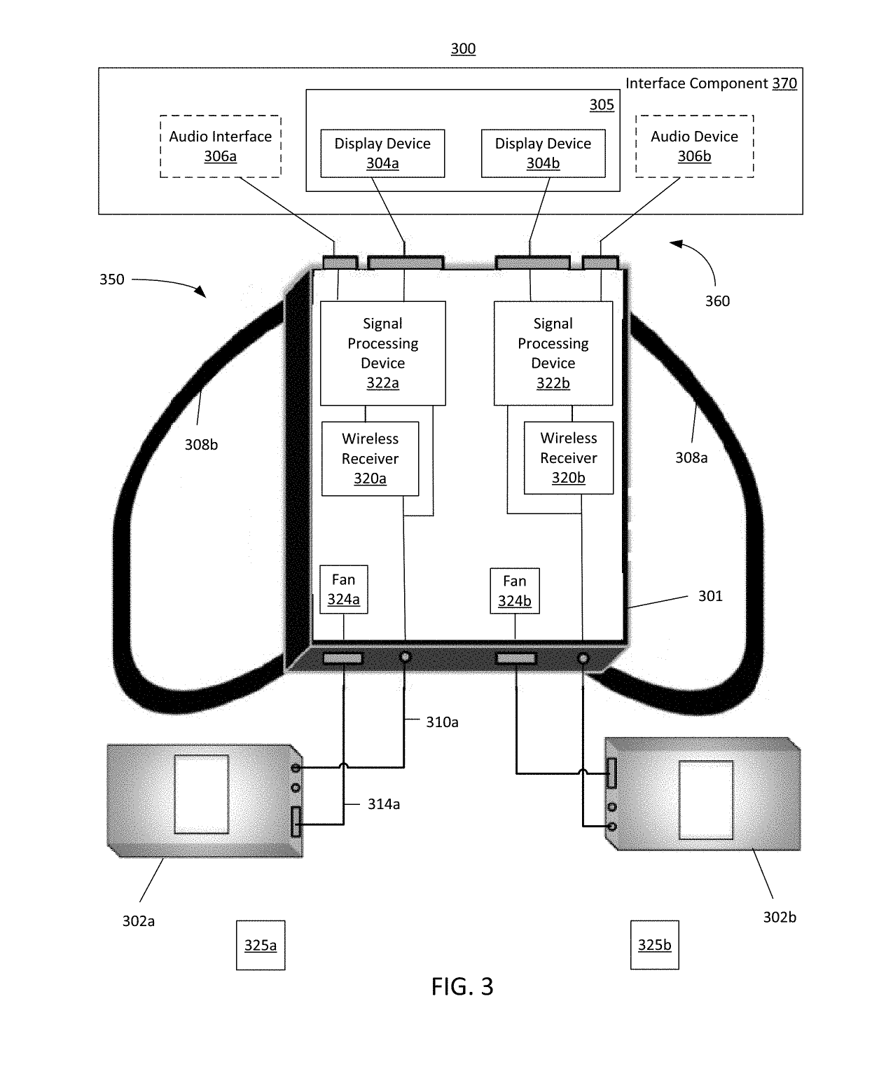

FIG. 3 is a schematic of a wireless presenting unit 300 adapted to communicate wirelessly with one or more remote computers configured to dynamically render a representation of a virtual environment to be presented to a wearer of the simulating unit 300, according to some embodiments. In some embodiments, presenting unit 104 of virtual reality system 100 may be implemented as a wireless presenting unit 300 configured to wirelessly communicate with rendering unit 102. In this respect, unit 300 is “wireless” with respect to the connection between the unit 300 and rendering unit 102. Unit 300 may include one or more wired connections, for example, between components of unit 300, between unit 300 and a head mounted display, etc. Wireless unit 300 includes a processing component 350 and interface connections 360 adapted to connect to an interface component 370, via either a wired or wireless connection (or both). Processing component 350 may be configured to wirelessly receive and process data from rendering unit 102 and provide the data to interface component 370 via interface connections 360 for presenting to the user. Interface component 370 may include a stereoscopic head mounted display 305 with one or more display devices (304a, 304b), may include one or more audio devices (306a, 306b) for playing audio and/or may include other suitable interface devices (e.g., a haptic interface).

Processing component 350 includes a first wireless receiver 320a and a second wireless receiver 320b configured to communicate wirelessly with respective wireless transmitters 325a and 325b, respectively. The wireless transmitters 325a and 325b may be coupled, either wirelessly or via a wired connection, to the one or more computers generating the representation of the virtual environment. In particular, wireless transmitter 325a and 325b may be coupled to receive data describing the stereoscopic representation of a virtual environment such that the left-eye component and the right-eye component of a stereoscopically rendered scene may be transmitted to and received by wireless receivers 320a and 320b, respectively. In some embodiments, the wireless receivers may receive the left-eye data component and the right-eye data component on separate frequency bands. For example, the first wireless receiver may receive the left-eye data component on a first frequency band, and the second wireless receiver may receive the right-eye data component on a second frequency band. The first and second frequency bands may be used exclusively or primarily by a virtual reality system to carry, respectively, left-eye data components and right-eye data components of the virtual environment (e.g., the virtual scene from perspective of the right eye and the left eye, respectively).

For example, the first wireless receiver may lock onto the first frequency band for a specified period of time, for a given session after initialization, or until powered down, and may receive a sequence of left-eye images (e.g., a sequence of left-eye video frames) while locked onto the first frequency band. Likewise, the second wireless receiver may lock onto the second frequency band for a specified period of time, for a given session after initialization, or until powered down, and may receive a sequence of right-eye images (e.g., a sequence of right-eye video frames) while locked onto the second frequency band. By using dedicated frequency bands to carry the two channels of the stereoscopic images, interference between the signals carrying the two channels may be eliminated, reduced to negligible levels, or reduced such that the signal-to-noise ratios of the received signals exceed a threshold signal-to-noise ratio.

The frequency bands used by the wireless receivers (320a, 320b) to receive the stereoscopic images may be determined by the wireless receivers, by the respective wireless transmitters (325a, 325b), by a user of wireless simulating unit 300, by an operator of virtual reality system 100, and/or by any other suitable technique (e.g., default settings). In some embodiments, a system operator (or user) may configure the wireless receivers (320a, 320b) of simulating unit 300 and the corresponding wireless transmitters (325a, 325b) of rendering unit 102 to communicate using respective frequency bands specified by the operator (or user). In some embodiments, the transmitters and receivers may communicate using only the specified frequency bands. In some embodiments, the specified frequency bands may be default or initial frequency bands used for transmission of stereoscopic video, and the transmitters and/or receivers may be configured to adapt to runtime conditions (e.g., interference in a frequency band being used for wireless communication) by selecting a different, non-congested frequency band.

In some embodiments, transmitter 325a may monitor a set of frequency bands to identify a band over which to lock onto and convene wireless communications. According to some embodiments, before locking onto an identified frequency band, a given wireless transmitter may communicate with the other transmitter (or any other transmitter within range) to either broadcast that the given transmitter will be using the identified frequency band or to poll other transmitters to ensure that no other transmitter has already locked onto the identified frequency band (or both), thus reserving the selected frequency band if it is determined not to be in use. If the attempt to reserve the identified frequency band fails, the transmitter may select a different frequency band for transmission and repeat the process until an available frequency band is located. In some embodiments, after locking onto the frequency band, the transmitter may send information to the other transmitter (or generally broadcast) that the selected frequency band is unavailable. Transmitters receiving an indication that a frequency band is in use or receiving a broadcast indicating same, may flag the frequency band as in use and refrain from selecting or transmitting over the selected band.

According to some embodiments, any of the above described frequency band negotiation techniques may be performed by the receivers instead of the transmitters, or the negotiation process may involve both transmitters and receivers, as identifying and locking onto separate frequency bands is not limited to any particular technique for doing so. According to some embodiments, transmitter/receiver pairs may dynamically change the frequency band over which communication occurs when interference, noise or other conditions make it suitable to do so. When a transmitter/receiver pair changes frequency bands, the transmitter/receiver pair may repeat any of the above negotiation techniques to ensure that an available frequency band is selected. As a result, stereoscopic data may be communicated wirelessly to the unit worn by the user and ultimately to, for example, the head mounted display, as discussed in further detail below.

In some embodiments, wireless receivers 320a and 320b may each comprise a Nyrius ARIES Pro Digital Wireless HDMI Transmitter and Receiver System, Model No. NPCS550. In some embodiments, wireless receivers 320a and 320b may be logical receivers implemented using a same physical wireless receiver configured to receive rendered representations of two channels of a stereoscopic image of the virtual environment (e.g., implemented as a single receiver having a single corresponding transmitter). In some embodiments, wireless receiver 320a and/or 320b may be configured to receive the rendered representations of the channels of the stereoscopic image using any suitable protocol (including, but not limited to, Wi-Fi, WiMAX, Bluetooth, wireless USB, ZigBee, or any other wireless protocol), any suitable standard (including, but not limited to, any of the IEEE 802.11 standards, any of the IEEE 802.16 standards, or any other wireless standard), or any suitable technique (including, but not limited to, TDMA, FDMA, OFDMA, CDMA, etc.).

In some embodiments, processing component 350 may include one or more signal processing devices (322a, 322b), which may be housed in enclosure 301 and communicatively coupled with wireless receivers 320a and 320b as illustrated in FIG. 3. The signal processing device(s) may be configured to convert video data from a first format to a second format. For example, signal processing device 322a may be configured to convert data received by wireless receiver 320a (e.g., a left-eye component of stereoscopic video of the virtual environment) from a first format (e.g., a format used by virtual environment rendering unit 102) to a second format (e.g., a format used by a left-eye display device 304a of head-mounted display 305). Signal processing device 322b may be configured to convert data received by wireless receiver 320b (e.g., a right-eye component of a stereoscopic video of the virtual environment) from a first format (e.g., a format used by virtual environment rendering unit 102) to a second format (e.g., a format used by a right-eye display device 304b of head-mounted display 305). In some embodiments, the first format may be HDMI (high-definition multimedia interface), and the second format may be LVDS (low-voltage differential signaling). In some embodiments, the first format and/or the second format may include HDMI, LVDS, DVI, VGA, S/PDIF, S-Video, component, composite, IEEE 1394 “Firewire”, interlaced, progressive, and/or any other suitable format. In some embodiments, the first and second formats may be the same.

In some embodiments, processing component 350 may include one or more fans (324a, 324b), which may be housed in enclosure 301 and configured to dissipate heat produced by the wireless receivers (320a, 320b) and/or the signal processing devices (322a, 322b). In some embodiments, enclosure 301 may be formed of a lightweight, non-conductive material. Limiting the weight of enclosure 301 may improve the user's experience by making wireless virtual environment simulating unit 300 less cumbersome. Using a non-conductive material may increase the quality of the signals received by the one or more wireless receivers housed in the enclosure. In some embodiments, enclosure 301 may be formed of any material suitable for housing the wireless receivers.

In some embodiments, processing component 350 may include one or more batteries (302a, 302b). The one or more batteries may be rechargeable batteries, including, but not limited to, lithium polymer batteries. The batteries may provide power to other components of wireless virtual environment simulating unit 300, including, but not limited to, the one or more wireless receivers (320a, 320b), the one or more signal processing devices (322a, 322b), the one or more fans (324a, 324b), and/or the interface component 370. The batteries may be mounted on the enclosure, housed within the enclosure, or arranged in any other suitable manner. The batteries may be coupled to other components of wireless presenting unit 300 to provide power to the other components. In some embodiments, battery 302a may be coupled to a fan by a USB connector 314a (e.g., a 5V USB connector). In some embodiments, battery 302a may be coupled to wireless receiver 320a and/or signal processing device 322a by connector 310a (e.g., a 12V power supply connector). Battery 304b may be coupled to fan 324b, wireless receiver 320b, and/or signal processing device 322b in like manner.

In some embodiments, processing component 350 may include or be disposed in a backpack, bag, or any other case, package or container suitable for carrying components of wireless presenting unit 300. As shown in FIG. 3, the carrying device may have two carrying straps 308a and 308b. In some embodiments, the carrying device may have zero, one, two, or more carrying straps or handles.

Interface component 370 is configured to present the rendered representation of the virtual environment to a user. In some embodiments, interface component 370 may include a head-mounted display 305 with a left-eye display device 304a and a right-eye display device 304b so as to provide stereoscopic data to the wearer. Left-eye display device 304a may be configured to stimulate the user to see the virtual environment by displaying left-eye images of the virtual environment to the user's left eye. Right-eye display device 304b may be configured to stimulate the user to see the virtual environment by displaying right-eye images of the virtual environment to the user's right eye. In some embodiments, head-mounted display 305 may include a display panel (e.g., a liquid-crystal display panel, light-emitting diode (LED) display panel, organic light-emitting diode (OLED) display panel, and/or any other suitable display) and/or a lens configured to focus an image displayed on the display panel onto a user's eye.

In some embodiments, interface component 370 may include one or more audio devices (e.g., speakers) configured to stimulate the user to hear the virtual environment by playing audio of the virtual environment. For example, interface component 370 may include a left-ear audio device 306a and a right-ear audio device 306b. Left-ear audio device 306a may be configured to play a first channel of audio of the virtual environment to the user's left ear. Right-ear audio device 306b may be configured to play a second channel of audio of the virtual environment to the user's right ear. In some embodiments, interface component 370 may be configured to play more than two channels of audio of the virtual environment (e.g., to produce “surround sound” audio). Although the interface component 370 illustrated in FIG. 3 is configured to play stereophonic audio of the virtual environment, embodiments of interface component may be configured to play no audio of the virtual environment or monophonic audio of the virtual environment.

In some embodiments, interface component 370 may include one or more haptic interfaces (not shown). The haptic interface(s) may be configured to stimulate the user to feel the virtual environment by applying force to the user's body. It should be appreciated that the wireless VR system described above provides substantial advantages over systems that require a cable connection between the one or more computers producing the virtual environment and a wearer of the head mounted display (e.g., between the head mounted display or wearable equipment and the rendering unit 102). The increased mobility and flexibility may dramatically improve the virtual reality experience and allow for entertainment, research and treatment applications that were not possible using systems that needed a cable tether between user and computer to provide data and/or power. Moreover, VR systems as described above may reduce costs at least with respect to expensive cabling susceptible to damage and malfunction such that frequent maintenance and replacement is often needed.

Some embodiments described above are capable of being utilized with conventional stereoscopic head-mounted displays, which themselves may have a number of significant drawbacks. In particular, such conventional head-mounted displays are relatively expensive, selling for multiple tens of thousands of dollars. Additionally, such conventional head-mounted displays generally have wired connections for data and/or power such that some form of cabling is still required. The inventors have developed a VR system including a wireless head-mounted display that eliminates cabling connections. According to some embodiments, the one or more computers adapted to generate and produce the virtual reality environment are implemented on the head-mounted display, thus eliminating the stationary computer (or computers) conventionally required to dynamically produce elements of the virtual reality environment (e.g., to produce a dynamic virtual scene responsive to the action of the user). Non-limiting examples of a portable, wireless virtual reality system are described in further detail below.

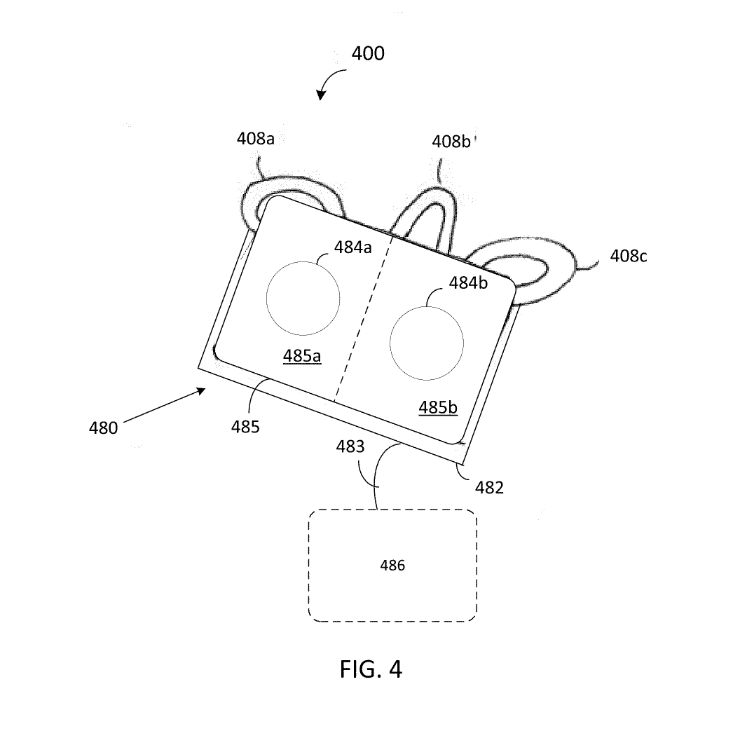

FIG. 4 is a schematic of a mobile virtual reality system 400, according to some embodiments. Virtual reality system 400 includes an integrated virtual reality device 480 and (optionally) a peripheral presentation device 486 and a communicative coupling 483 between peripheral presentation device 486 and integrated VR device 480. Integrated VR device 480 may include the computing resources to generate a virtual reality environment, the rendering capabilities to present the virtual reality environment to the user, and/or mobile position and/or orientation tracking units (in this respect, integrated VR device 480 may implement rendering unit 102, presenting unit 104, position tracking unit 106, and/or orientation tracking unit 108 of the system described in connection with FIG. 1). By doing so, integrated VR device 480 may be self-contained, portable and wireless in this respect. As a result, integrated VR device 480 may be free from many of the restrictions placed upon virtual reality systems requiring separate computing resources (e.g., one or more stationary computers) to produce the virtual reality environment, as discussed in further detail below.

Peripheral presentation device 486 may be configured to stimulate one or more of a user's senses to perceive a rendered representation of a virtual environment. In some embodiments, peripheral presentation device 486 may include an audio presentation device (e.g., a speaker), a video presentation device (e.g., a display), and/or a haptic interface. Communicative coupling 483 may be wired or wireless. According to some embodiments, one or more capabilities of peripheral presentation device 486 (which itself is merely optional) may be implemented on integrated VR device 480, as the aspects are not limited in this respect.

Integrated VR device 480 may include a display 485 adapted to provide stereoscopic data to the user. According to some embodiments, display 485 is a single display having a first display area 485a to display visual data from the perspective of one eye and a display area 485b to display visual data from the perspective of the other eye. As discussed above, integrated VR device 480 may include the computing resources needed to generate and produce a virtual reality environment, for example, a dynamic scene to be displayed on display 485. Integrated VR device 480 may also include computing resources (e.g., software operating on one or more processors) configured to generate the scene stereoscopically and separately present the visual data from the different perspectives of the user's eyes on display area 485a and 485b, respectively. According to some embodiments, display area 485a and 485b are separate displays. According to some embodiments, optical components 484a and 484b (e.g., optical lenses) are coupled to display 485 to focus the user's eyes on the corresponding display area 485a and 485b so that the user's eyes receive visual data from the correct areas to provide a realistic, stereoscopic presentation of the scene.

In some embodiments, integrated VR device 480 may include a mobile position tracking unit and/or a mobile orientation unit, and the integrated VR device 480 may update the presentation of the virtual environment according to the position and/or orientation of the user as determined by the mobile position tracking unit and/or mobile orientation unit.

Integrated VR device 480 includes a mounting unit 482 configured to mount and/or attach integrated VR device 480 to a user (for example, to the user's head) and to position and secure the device during use. In some embodiments, mounting unit 482 may include one or more straps 408 configured to attach mounting unit 482 to a user's head so that the user's eyes are positioned correctly relative to the one or more optical components 484 (e.g., lenses 484a and 484b). Accordingly, integrated VR device 480 may be a self-contained VR system that provides a highly flexible and mobile VR system, as discussed in further detail below.

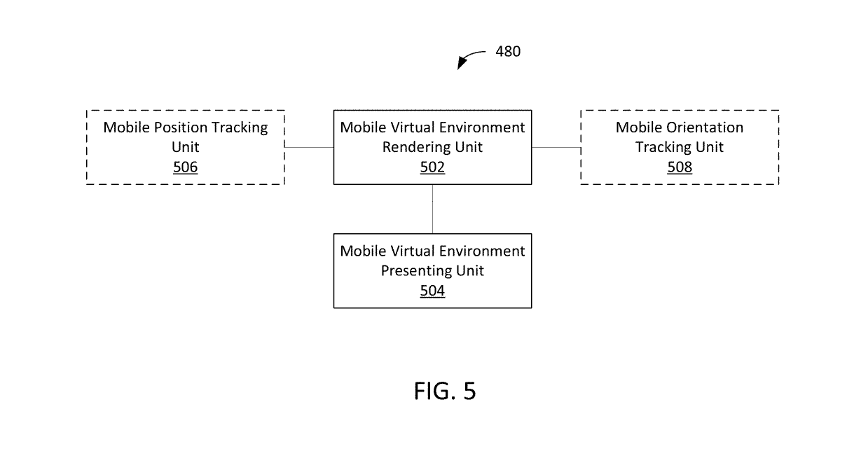

FIG. 5 is a block diagram of a mobile integrated virtual reality device 480, according to some embodiments. As shown in FIG. 5, an integrated VR device 480 may include a mobile virtual environment rendering unit 502, a mobile virtual environment presenting unit 504, a mobile position tracking unit 506, and/or a mobile orientation tracking unit 508. Mobile position tracking unit 506 may determine a position of an object (e.g., the user) in a reference environment and generate reference positioning data representing the object's position in the reference environment. Mobile orientation tracking unit 508 may determine an orientation of an object (e.g., the user's head) in a reference environment and generate reference orientation data representing the object's orientation in the reference environment. In some embodiments, the position and/or orientation tracking may be implemented by computing resources on integrated virtual reality device 480 (e.g., using GPS, one or more inertial motion units, one or more motion capture systems, etc.). Mobile position and/or orientation tracking may, in some embodiments, be partially (or entirely) implemented by computing resources external to integrated virtual reality device 480, as discussed in further detail below. In some embodiments, mobile position tracking and/or orientation tracking may be implemented, at least in part, using computing resources of integrated virtual reality device 480.

As discussed above, integrated VR device 480 may include hardware, software, or a combination of hardware and software configured to implement functions of mobile virtual environment rendering unit 502, mobile virtual environment presenting unit 504, mobile position tracking unit 506, and/or mobile orientation tracking unit 508. In some embodiments, integrated VR device 480 may include a mobile computer (e.g., mobile phone or tablet computer), including, but not limited to, an Asus Nexus 7 tablet computer. In some embodiments, integrated VR device 480 may include a display (e.g., a high-resolution display, such as a retina display) to provide stereoscopic capabilities as described above (e.g., to display left-eye and right-eye components of stereoscopic images of a dynamically changing scene). In some embodiments, integrated VR device 480 may include a platform for integrating hardware and software configured to perform virtual environment rendering, virtual environment simulation, position tracking, orientation tracking, and/or any other suitable task related to immersing a user in a virtual environment. In some embodiments, the integration platform may be compatible with a mobile operating system (e.g., an Android operating system).

In some embodiments, integrated VR device 480 may include a mobile position tracking unit 506. Some embodiments of mobile position tracking unit 506 may include hardware, software, or a combination of hardware and software configured to determine a position of an object in a reference environment and generate reference positioning data representing the object's position in the reference environment. In some embodiments, mobile position tracking unit 506 may be configured to perform the functions of position tracking unit 106.

The integration of mobile position tracking unit 506 in integrated VR device 480 may reduce or eliminate constraints on user mobility imposed by the body tracking systems of some conventional VR systems. As discussed above, some conventional VR systems may use tracking devices external to the user (e.g., a fixed sensor grid, set of cameras, ultrasonic array and/or electromagnetic system), often in combination with sensors attached to the user, to track a user's position, thereby limiting the user's mobility to a small reference environment determined by the range of the body tracking system. In some embodiments, mobile position tracking unit 506 may include a satellite navigation system receiver (e.g., a global positioning system (GPS) receiver or a global navigation satellite system (GLONASS) receiver), an inertial motion unit (e.g., a positioning system configured to determine a user's location based on an initial location and data collected from inertial sensors, including, without limitation, accelerometers, gyroscopes, and/or magnetometers), a mobile motion capture system, and/or any other mobile positioning system. The integration of a mobile position tracking unit 506 into integrated VR device 480 may significantly increase the size of the reference environment in which VR system 400 can track the user's position and/or decrease the expense at which a reference environment can be implemented (e.g., virtually any space may be utilized as a reference environment as a consequence).

In some embodiments, markers may be arranged at known positions in a reference environment, and integrated VR device 480 may be configured to use the markers to determine the user's location. For example, integrated VR device 480 may include one or more cameras, and may be configured to use the camera(s) to acquire images of the reference environment. Integrated VR device 480 may be configured to process the acquired images to detect one or more of the markers, to determine the position(s) of the detected marker(s), and to determine the user's position in the reference environment based on the position(s) of the detected marker(s). In some embodiments, VR system 400 may include a motion capture system (e.g., Microsoft Kinect) configured to detect movement of a user in a reference environment and/or portions of the user's body.

In some embodiments, mobile positioning unit 506 may include a mobile motion capture system configured to determine the user's position based on one or more images acquired of the user's environment. In some embodiments, the mobile motion capture system may include one or more cameras (e.g., one or more visible-light cameras, infrared camera, and/or other suitable cameras) configured to obtain image data (e.g., video) of the user's environment. The one or more cameras may be positioned to acquire images generally in the direction that the user is facing when integrated VR device 480 is worn by the user. The one or more cameras of the mobile positioning unit 506 may, for example, be mounted to a device adapted to be worn by the user, such as mounted to a housing worn on the head of the user (e.g., a helmet or a visor, etc.). According to some embodiments, stereo cameras (and/or an array of cameras facing forward, peripheral and/or to rear) are provided in fixed and known positions relative to one another to allow image data to be acquired from different perspectives to improve detection of features in the acquired image data. As used herein, a “feature” refers to any identifiable or detectable pattern in an image. A feature may correspond to image information associated with one or more reference objects artificially placed in the environment or may correspond to one or more reference objects that appear as part of the natural environment, or a combination of both. For example, reference objects designed to be detectable in image data may be placed at known locations in the environment and used to determine a position and/or orientation of the user (e.g., wearer) based on detecting the reference objects in the image data. Alternatively, reference objects existing in the environment may likewise be detected in image data of the environment to compute the position and/or orientation of the user of the system. Features corresponding to reference objects may be detected using any image processing, pattern recognition and/or computer vision technique, as the aspects are not limited in this respect. The appearance of the reference objects in the image data, alone or relative to other reference objects in the image data, may be used to compute the position and/or orientation of the wearer of the mobile positioning unit 506 and/or the motion capture system of the mobile positioning unit 506.

Cameras utilized for determining the position and/or orientation of a user are not limited to cameras sensitive to light in the visible spectrum and may include one or more other types of cameras including infrared cameras, range finding cameras, light field cameras, etc. In some embodiments, the mobile motion capture system may include one or more infrared emitters, light sources (e.g., light-emitting diodes), and/or other devices configured to emit electromagnetic signals of suitable wavelengths. In some embodiments, the mobile motion capture system may use such signal-emitting devices to irradiate the environment around the user with electromagnetic radiation to which the mobile motion capture system's camera(s) are sensitive, thereby improving the quality of the images obtained by the motion capture system. For example, in some embodiments, the mobile motion capture system may use one or more infrared emitters to emit infrared signals into the user's environment (e.g., in a particular pattern), and may use one or more infrared cameras to obtain images of that environment. Some embodiments of the mobile motion capture system may use one or more light sources to emit visible light into the user's environment, and may use one or more visible-light cameras to obtain images of that environment. However, as discussed above, cameras may acquire image data using the ambient radiation in the spectrum to which the cameras are sensitive without producing or emitting additional radiation.

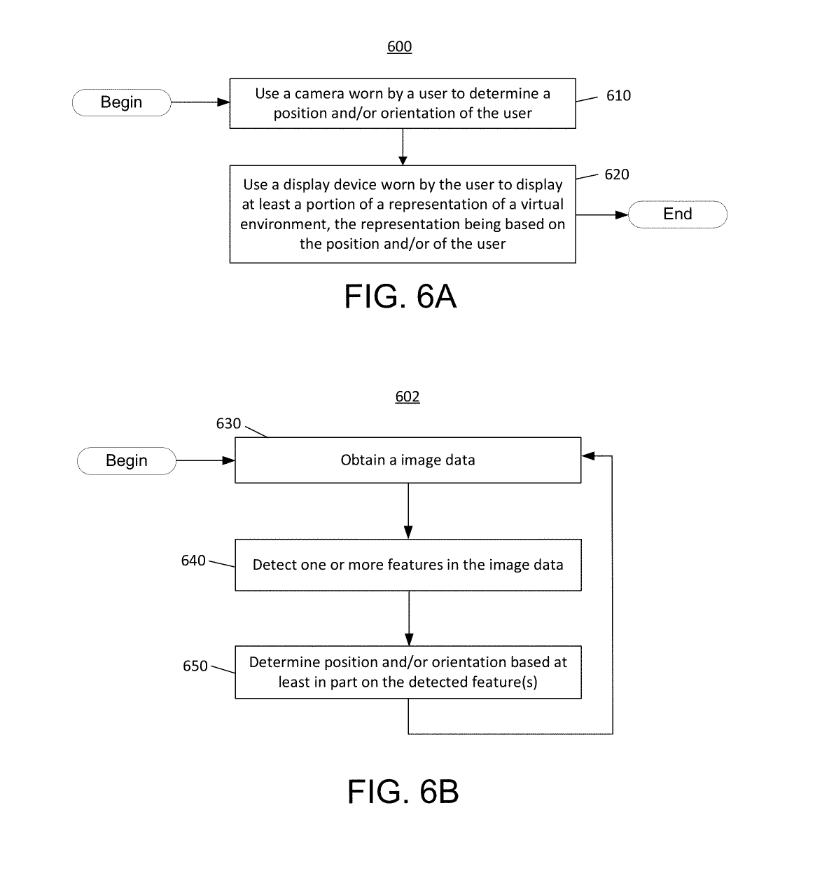

In some embodiments, the mobile motion capture system may be used to perform position and/or orientation determination to facilitate a highly mobile VR system, thus enriching the immersiveness of the VR experience by allowing for levels of mobility not otherwise achievable. FIG. 6A is a flowchart illustrating a method 600 for rendering a virtual environment to a user, according to some embodiments. In step 610, one or more cameras worn by the user (e.g., one or more cameras mounted to a mobile motion capture system included in an integrated VR device 480 worn by the user) is used to determine a position and/or orientation associated with the user (e.g., the position and/or orientation of the user, the position and/or orientation of the one or more cameras, the position and/or orientation of a fixed or known location of the motion capture system, integrated VR device, etc.). In step 620, a display device worn by the user is used to render at least a portion of a representation of the virtual environment based, at least in part, on the determination of the position and/or orientation associated with the user determined from the image data acquired by the motion capture system. As discussed above, the motion capture system may include one or more cameras configured to obtain images based on detecting radiation in one or more portions of the electromagnetic spectrum (e.g., visible, infrared, etc.). The motion capture system may further include software configured to process the images to detect one or more features in the images and compute a position and/or orientation of the user from the detected features (e.g., based on the appearance of the features and/or the relationship between multiple features detected in the images), as discussed in further detail below.

FIG. 6B shows a method 602 for determining a position and/or orientation of a user of a virtual reality device, according to some embodiments. In some embodiments, the virtual reality device may include an integrated VR device 480 worn by the user. In some embodiments, the integrated VR device 480 may include a mobile motion capture system having one or more cameras as discussed above. In some embodiments, the method 602 of FIG. 6B may be used to implement step 610 of method 600.

In step 630 of method 602, one or more cameras of the mobile motion capture device is controlled to obtain image data (e.g., by acquiring video of the environment during a given interval of time). The image data may include a single image or a multiple images (e.g., a sequence of successive images) and may include single or multiple image(s) from a single camera or multiple cameras. In step 640 of method 602, the image data is analyzed to detect features in the image data. The features may correspond to detectable patterns in the image and/or may correspond to one or more reference objects in the scene or environment from which the image data is acquired. As discussed above, reference objects may be any one or more objects in the environment capable of being detected in images of the environment. For example, reference objects may be objects existing or artificially placed in an environment that have a detectable pattern that gives rise to features in image data acquired of the environment that can be distinguished from other image content. According to some embodiments, the reference objects have known locations in the environment and/or known positions relative to one another.

Upon detecting one or more features, the appearance of the features, either alone or in relation to other detected features, may be evaluated to determine the position and/or orientation from which the image was acquired. For example, features detected in the images may provide indications of the size, shape, direction, and/or distance of reference objects as they appear in the image data. This information may be evaluated to facilitate determining the position and/or orientation from which the corresponding image data was acquired. The relationship between multiple features, e.g., features corresponding to multiple reference objects detected in the images, may also be used to assist in determining position and/or orientation. When multiple cameras are utilized, the appearance of the same features (e.g., features corresponding to reference object(s)) from the different perspectives of the multiple cameras may be used to compute the position and/or orientation of a user wearing a motion capture device comprising the multiple cameras. Any and/or all information obtained or derived from analyzing detected features as they appear in the image data can be used to compute the position and/or orientation from which the image data was acquired, which can in turn be used to estimate the current position and/or orientation of the wearer of the motion capture device. While features detected in image data may advantageously correspond to reference objects in the environment, features can correspond to any detectable pattern in acquired image data, as the aspects are not limited in this respect.

Method 602 may be repeated on subsequently acquired image data to update the position and/or orientation of the user as the user moves about the environment. As a result, the motion capture device may be configured to track the movement of the wearer of the device. When a subsequent image data is obtained, the position and/or orientation of the user may be determined using both the previously acquired image data and the current image data to understand how the user has moved during the interval between the time acquisition of the two sets of image data. Alternatively, the subsequent image data may be used independent of the previously acquired image data to determining position and/or orientation associated with the user. That is, position and/or orientation may be determined relative to a previous position/orientation computer from previous image data based or determined absolutely from given image data, as the aspects are not limited in this respect. In some embodiments, a user's initial location in an environment is determined with the assistance of other technologies such as GPS information, a priori information, or other available information. This information may be used to bootstrap the determination of position and/or orientation associated with the user, though such information is not required or used in some embodiments.

In some embodiments, integrated VR device 480 may include a mobile orientation tracking unit 508. Some embodiments of mobile orientation tracking unit 508 may include hardware (e.g., an inertial motion unit, a camera-based motion capture system, and/or other rotational tracking system), software, or a combination of hardware and software configured to determine an orientation (e.g., roll, pitch, and/or yaw) of a part of a user in a reference environment and to generate reference orientation data representing the user's orientation in the reference environment. In some embodiments, mobile orientation tracking unit 508 may be configured to perform the functions of orientation tracking unit 108. In some embodiments, mobile orientation tracking unit 508 may be configured to detect an orientation of a user's head. According to some embodiments, orientation information obtained from an inertial motion unit may be provided to or used in combination with the motion capture unit to improve the accuracy of determining the position and orientation of the user. In this way, different modalities can be used together to improve user tracking to facilitate a highly mobile and flexible virtual reality experience.

In some embodiments, integrated VR device 480 may include a mobile virtual environment rendering unit 502. Some embodiments of mobile virtual environment rendering unit 502 may include hardware, software, or a combination of hardware and software configured to render a representation of a virtual environment. In some embodiments, mobile virtual environment rendering unit 502 may be configured to perform the functions of virtual environment rendering unit 102. In some embodiments, mobile virtual environment rendering unit 502 may include virtual environment rendering software including, but not limited to, Unity, Unreal Engine, CryEngine, and/or Blender software. According to some embodiments, the rendering software utilized may allow for generally efficient and fast creation of a virtual environment, either based on a real environment or wholly virtual.

In some embodiments, mobile virtual environment rendering unit 502 may use positioning data indicating a position of a user or a part of the user, and/or orientation data indicating an orientation of a user or a part of the user, to render interaction in the virtual environment between a representation of the user and some portion of the virtual environment. Rendering interaction between a representation of a user and some portion of a virtual environment may include rendering movement of an object in the virtual environment, deformation of an object in the virtual environment, and/or any other suitable change in the state of an object in the virtual environment. The movement, deformation, or other state change of the object in the virtual environment may be rendered in response to movement of a user in the reference environment. The positioning data may be generated by mobile position tracking unit 506. The orientation data may be generated by mobile orientation tracking unit 508.

In some embodiments, mobile virtual environment rendering unit 502 may render an avatar in the virtual environment to represent the user of VR system 400. Mobile virtual environment rendering unit 502 may include software suitable for render an avatar representing a user, including, but not limited to, Qualisys software.

In some embodiments, the integration of virtual reality functions in an integrated VR device 480 may enhance a user's mobility by reducing or eliminating the constraints on user mobility typically imposed by conventional VR systems. In a conventional VR system, the user's mobility may be limited by the length of a cable tethering the user's head-mounted display (HMD) to a stationary computer configured to render a representation of the virtual environment, by the range of wireless transceivers used to implement a wireless solution, and/or by the range of an external position and/or orientation tracking system used to determine the user's position and/or orientation in a reference environment. Some embodiments of integrated VR device 480 include a mobile virtual environment rendering unit 502 and a mobile virtual environment presenting unit 504, thereby reducing or eliminating any restrictions on the user's mobility associated with the communicative coupling between components used for producing a representation of a virtual environment and components used for presenting the representation of the virtual environment. Some embodiments of integrated VR device 480 include a mobile position tracking unit 506 and/or a mobile orientation tracking unit 508, thereby reducing or eliminating any restrictions on the user's mobility associated with the limited range of an external position and/or orientation tracking system. Since some embodiments integrate these computing resources on the device worn by the user, the user is provided with increased mobility, flexibility and applicability.

Many virtual reality applications benefit from multi-player or multi-user interaction. Conventionally such multi-player interaction was severely limited due to cable restrictions as discussed above or due to interference between the VR systems corresponding to the multiple users. As such, multi-user interaction was severely limited or impossible. The inventors have appreciated that aspects of the integrated VR system 480 described herein may facilitate multi-user interaction and communication, for example, by utilizing wireless network technology (e.g., WiFi) In some embodiments, two or more integrated virtual reality devices 480 may be configured to wirelessly communicate with each other and/or with a remote server to simultaneously immerse two or more respective agents in a shared virtual environment. Wireless communication between integrated VR devices 480 or between an integrated VR device 480 and a remote server may be performed using any suitable communication protocol (including, but not limited to, Wi-Fi, WiMAX, Bluetooth, wireless USB, ZigBee, or any other wireless protocol), any suitable standard (including, but not limited to, any of the IEEE 802.11 standards, any of the IEEE 802.16 standards, or any other wireless standard), any suitable technique (including, but not limited to, TDMA, FDMA, OFDMA, CDMA, etc.), and over any suitable computer network (e.g., the Internet). By using wireless network standards, virtually any number of user's may be capable of communicating and interacting in a shared virtual environment.

In some embodiments, a set of integrated VR devices 480 may be configured to simultaneously immerse a number of agents in a shared virtual environment, wherein the number of simultaneous agents is any number of agents from two agents to tens, hundreds or even thousands of agents. In some embodiments, at least one of the agents immersed in the shared environment may be a person (“user”). In some embodiments, at least one of the agents immersed in the shared environment may be an intelligent agent (e.g., a computer or computer-controlled entity configured to use artificial intelligence to interact with the virtual environment). In some embodiments, agents that are simultaneously immersed in a virtual environment may be located in close proximity to each other (e.g., in the same room, or separated by less than 50 feet) and/or remote from each other (e.g., in different rooms, in different buildings, in different cities, separated by at least 50 feet, separated by at least 100 feet, separated by at least 500 feet, and/or separated by at least 1 mile). Since agents/users need not be located proximate each other, there is practically no limit to the number of users that can communicate and interact in a shared virtual environment.

Some embodiments have been described in which a rendered representation of a virtual environment is wirelessly received by a virtual reality device worn by a user. In some embodiments, such a virtual reality device may include a mobile motion capture system, mobile position tracking unit 506, and/or mobile orientation tracking unit 508. In some embodiments, the rendering engine is located on the virtual reality device worn by the user and in other embodiments the rending engine is located remotely from and communicates wirelessly with the virtual reality device worn by the user. In this latter respect, the rendering engine can be shared by multiple users with the rendering engine communicating the appropriate rendering information to the virtual reality device worn by the respective multiple users via wireless communication (e.g., via a WiFi or other wireless communication protocol) to facilitate multi-user virtual reality environments. Multiple users in this respect can be co-located or located remotely from one another to provide a multi-user experience in a wide array of circumstances and applications.

In some embodiments, the techniques and devices described herein may be used to implement virtual reality applications or aspects thereof, including, without limitation, combat simulation (e.g., military combat simulation), paintball, laser tag, optical control of robots and/or unmanned aerial vehicles (UAVs), distance learning, online education, architectural design (e.g., virtual tours), roller coasters, theme park attractions, medical rehabilitation (e.g., for concussions, sports injuries, prosthetics, orthotics, Parkinson's disease and/or other disorders affecting the brain, post-traumatic stress disorder), athletic training, treadmills, museums, collaborative work (e.g., virtual conference rooms or design studios), and/or video games. In some embodiments, the techniques and devices described herein may be used to implement aspects of augmented reality applications.

As discussed above, embodiments of virtual reality systems may provide more mobile, flexible and/or inexpensive virtual reality solutions. U.S. Provisional Patent Application No. 61/896,329, incorporated herein by reference, describes particular non-limiting examples of virtual reality systems incorporating aspects of techniques described herein. The '329 provisional application describes some embodiments of wireless virtual reality simulating unit 300 and some embodiments of mobile virtual reality system 400. The embodiments described in the '329 provisional application are non-limiting examples, and statements contained in the '329 provisional application should not be construed as limiting. Rather, the '329 provisional application should be read as disclosing examples of ways such systems may be implemented and describing some possible features that may be implemented, specific components that may be utilized and certain benefits that may be achieved, though none are requirements or limitations in this respect.

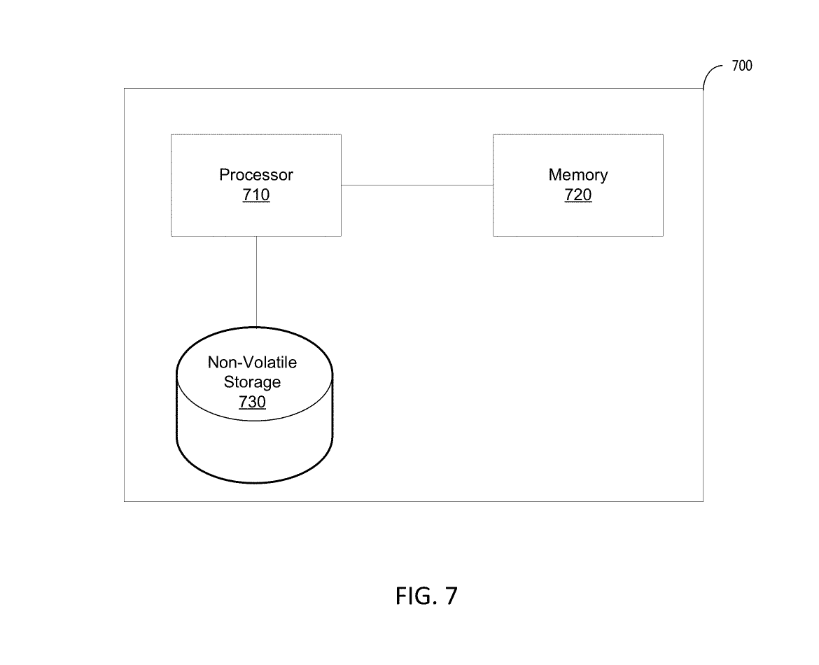

An illustrative implementation of a computer system 700 that may be used to implement one or more components and/or techniques described herein is shown in FIG. 7. For example, embodiments of computer system 700 may be used to implement integrated virtual reality device 480, mobile virtual environment rendering unit 502, mobile virtual environment presenting unit 504, mobile position tracking unit 506, and/or mobile orientation tracking unit 508. Computer system 700 may include one or more processors (e.g., processing circuits) 710 and one or more non-transitory computer-readable storage media (e.g., memory 720 and one or more non-volatile storage media 730). The processor(s) 710 may control writing data to and reading data from the memory 720 and the non-volatile storage device 730 in any suitable manner, as the aspects of the invention described herein are not limited in this respect. In some embodiments, computer system 700 may include memory 720 or non-volatile storage media 730, or both memory 720 and non-volatile storage media 730.

To perform functionality and/or techniques described herein, processor(s) 710 may execute one or more instructions stored in one or more computer-readable storage media (e.g., the memory 720, storage media 730, etc.), which may serve as non-transitory computer-readable storage media storing instructions for execution by processor(s) 710. Computer system 700 may also include any other processor, controller or control unit configured to route data, perform computations, perform I/O functionality, etc. For example, computer system 700 may include any number and type of input functionality to receive data and/or may include any number and type of output functionality to provide data, and/or may include control apparatus to perform I/O functionality.

In connection with rendering a representation of a virtual environment, simulating a rendered representation of a virtual environment, tracking a position of a user and/or object in a reference environment, and/or tracking an orientation of a user and/or object in a reference environment, one or more programs configured to perform such functionality, or any other functionality and/or techniques described herein may be stored on one or more computer-readable storage media of computer system 700. In particular, some portions or all of an integrated virtual reality device 480 may be implemented as instructions stored on one or more computer-readable storage media. Processor(s) 710 may execute any one or combination of such programs that are available to the processor(s) by being stored locally on computer system 700. Any other software, programs or instructions described herein may also be stored and executed by computer system 700. Computer system 700 may be implemented in any manner and may be connected to a network and capable of exchanging data in a wired or wireless capacity.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Data structures may be stored in one or more non-transitory processor-readable storage media in any suitable form. For simplicity of illustration, data structures may be shown to have fields that are related through location in the data structure. Such relationships may likewise be achieved by assigning storage for the fields with locations in a non-transitory processor-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting.

What is claimed is:

1. A virtual reality device configured to present to a user a virtual environment, the virtual reality device comprising:
a tracking device including at least one camera to acquire image data, the tracking device, when worn by the user, configured to determine a position associated with the user; and
a stereoscopic display device configured to display at least a portion of a representation of the virtual environment, wherein the representation of the virtual environment is based, at least in part, on the determined position associated with the user, wherein the display device and the tracking device are configured to be worn by the user.

2. The virtual reality device of claim 1, wherein the tracking device is configured to identify one or more features in the image data and to determine the position based, at least in part, on the one or more features.

3. The virtual reality device of claim 1, wherein the one or more features correspond to at least one reference object in the image data, and wherein the position is determined based, at least in part, on one or more attributes of the at least one reference object in the image data.

4. The virtual reality device of claim 3, wherein the one or more attributes includes size, shape and/or location of the at least one reference object.

5. The virtual reality device of claim 3, wherein the tracking device is configured to identify at least one reference object in first image data and identify the same at least one reference object in second image data, wherein the position is determined based at least in part on differences between one or more attributes of the at least one reference object in the first image data and the second image data.

6. The virtual reality device of claim 5, wherein the one or more attributes includes size, shape and/or location of the at least one reference object.

7. The virtual reality device of claim 3, wherein the tracking device is configured to identify a plurality of reference objects in the image data and wherein the position is determined based at least in part on at least one relationship between the plurality of reference objects in the image data.

8. The virtual reality device of claim 7, wherein the relationship includes relative size, relative shape and/or relative location of the plurality of reference objects.

9. The virtual reality device of claim 1, wherein the at least one camera comprises at least one infrared camera.

10. The virtual reality device of claim 9, wherein the tracking device further includes one or more infrared emitters configured to emit infrared radiation, and wherein the tracking device is configured to use the infrared camera and the infrared radiation to determine, at least in part, the position associated with the user.

11. The virtual reality device of claim 1, wherein the tracking device is configured to determine an orientation associated with the user.

12. The virtual reality device of claim 11, wherein the tracking device is configured to determine the orientation based, at least in part, on the image data from the at least one camera.

13. The virtual reality device of claim 11, wherein the tracking device further includes at least one inertial motion component configured to provide inertial information, and wherein the tracking device is configured to determine the orientation based, at least in part, on the inertial information from the at least one inertial motion component.

14. The virtual reality device of claim 13, wherein the tracking device is configured to determine the orientation based, at least in part, on the inertial information and the image data.

15. The virtual reality device of claim 11, further comprising a rendering unit configured to render the representation of the virtual environment based, at least in part, on a model of the virtual environment and on the position and/or orientation of the user.

16. The virtual reality device of claim 15, wherein the rendering unit is configured to be worn by the user.

17. The virtual reality device of claim 15, wherein the rendering unit is remote from the user and wirelessly receives the position and/or orientation and wirelessly transmits the representation of the virtual environment for display on the stereoscopic display device.

18. The virtual reality device of claim 1, wherein the virtual reality device is a first virtual reality device, wherein the representation of the virtual environment is a first representation of the virtual environment, wherein the user is a first user, and wherein the first virtual reality device is configured to communicate with a second virtual reality device configured to display at least a portion of a second representation of the same virtual environment to a second user based, at least in part, on a position of the second user.

19. The virtual reality device of claim 1, wherein the determined position corresponds to a location in a physical environment and/or coordinates in a reference coordinate system.

20. The virtual reality device of claim 1, wherein the at least one camera includes a plurality of cameras arranged in fixed and known locations relative to one another, wherein at least one of the cameras acquires image data from the perspective of the user.
